(19) United States
(12) Patent Application Publication
(10) Pub. No.: US 2015/0332301 A1
(43) Pub. Date: Nov. 19, 2015

(54) Transaction Discount Systems and Methods

(71) Applicant: MASTERCARD INTERNATIONAL INCORPORATED, Purchase, NY (US)

(72) Inventor: Shekhar Sahgal, Stamford, CT (US)

(73) Assignee: MASTERCARD INTERNATIONAL INCORPORATED, Purchase, NY (US)

(21) Appl. No.: 14/276,119

(22) Filed: May 13, 2014

(51) Int. Cl. G06Q 30/02; G06Q 20/32; G06Q 20/28; G06Q 20/24; G06Q 20/26

(52) U.S. Cl. CPC G06Q 30/0215; G06Q 20/24; G06Q 20/26; G06Q 20/28; G06Q 20/3278

(57) ABSTRACT

Systems and methods for applying a transaction discount to a payment account are disclosed. In one exemplary system, a transaction discount system includes a memory having a discount database identifying discounted transaction types, a discount amount per discounted transaction type for an account type, and where each discounted transaction type is associated with a sponsor account. A server receives an electronic transaction from a payment device associated with a payment account. The server is coupled to the memory and includes computer-executable instructions defining a consumer transaction discount program that authorizes a full payment of the electronic transaction on the payment account and further credits the payment account the discount amount when the electronic transaction matches the discounted transaction type and the payment account matches the account type. The consumer transaction discount program also further debits the sponsor account for the discount amount.

### FIELD

The present disclosure relates to a transaction discount system for fully paying a transaction on an account, applying a discount amount to the account when the transaction on the account matches a discount transaction type stored in a database, and debiting the discount amount to a sponsor account.

### BACKGROUND

This section provides background information related to the present disclosure which is not necessarily prior art.

It is known for automatic teller machine (ATM) systems to charge transaction fees for ATM users that are not customers of the ATM owner. It is also known for various ATM owners, typically banks or other financial institutions, to have agreements with each other not to charge transaction fees for each other's customers. These agreements typically require the ATM system to access a list of ATM card numbers that are not to be charged a transaction fee. If the ATM card number is not on the list, then the ATM account will be charged transaction fees. If the ATM card number is on the list then no transaction fees are charged. These ATM transactions prevent charging of fees based on only the ATM card number.

It would advantageous to provide an electronic transaction payment system that fully paid the electronic transaction, including any associated fees, on a cardholder account and permitted a sponsor to credit a discount to the cardholder account for certain discount transaction types, such as refunding associated fees, and the system debiting a sponsor account for the cost of the discount credited to the cardholder account.

### DRAWINGS

The drawings described herein are for illustrative purposes only of selected embodiments and not all possible implementations, and are not intended to limit the scope of the present disclosure.

FIG. 1 is an exemplary system for use with possible embodiments of a transaction discount system; and

FIG. 2 is a flowchart of an exemplary logic flow for an embodiment of a discount transaction program.

Corresponding reference numerals indicate corresponding parts throughout the several views of the drawings.

### DETAILED DESCRIPTION

Examples will now be described more fully with reference to the accompanying drawings.

The examples described below provide a network payment provider a system for conveniently enabling a third party to provide a consumer a discount when the consumer makes a particular type of purchase or if the consumer uses a particular type of account to make the purchase. This is especially beneficial for transactions where fees are associated with a purchase. In such an instance, the example embodiments below provide full payment of the purchase, including associated fees, while also refunding the fees or a portion of the fees to the consumer's account. Conveniently, the fees refunded are then debited from a sponsor account to pay for the consumer refund.

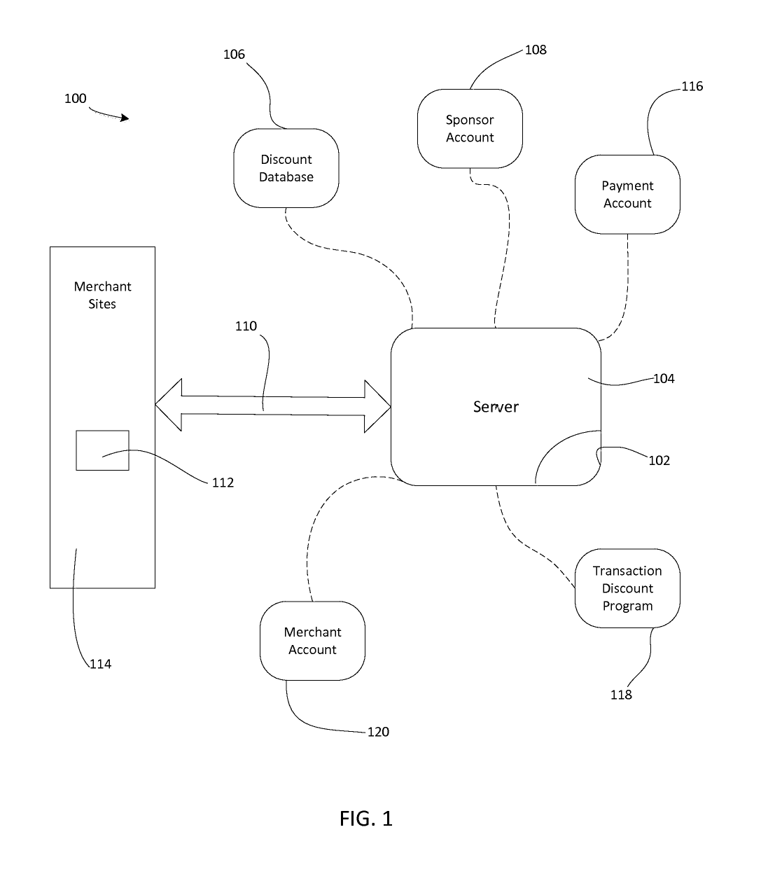

FIG. 1 shows an exemplary transaction discount system 100. The system 100 includes a memory 102 coupled to a server 104. The server 104 may be one or more computer servers at one or more locations and may be a part of a network payment provider system, such as MasterCard®. The memory may include one or more computer-readable media, such as, without limitation, dynamic random access memory (DRAM), static random access memory (SRAM), a solid state disk, and/or a hard disk. In this embodiment, the memory 102 includes a discount database 106. The discount database 106 includes at least one discounted transaction type and a discount amount per discounted transaction type for at least one account type and each discounted transaction type is associated with at least one sponsor account 108.

The server 104 receives an electronic transaction, as indicated by arrow 110, from a payment device 112 used at a merchant site 114. The payment device 112 is associated with a payment account 116. The arrow 110 may represent a number of different connections between merchant sites 114, and different components of a payment network, including the server 104. For example, the arrow 110 may include a known transaction flow through an acquirer, a payment service provider, to an issuer. The server 104 may be associated with any one or more of the acquirer, payment service provider, the issuer, or another entity involved in or associated with a transaction. The arrow 110 may include, for example, connections via one or more different public and private networks, including local area networks (LAN), wide area networks (WAN), wired telecommunications systems (e.g., telephone), and/or a wireless communication systems, such as cellular or satellite systems.

The server 104 coupled to the memory 102 includes computer-executable instructions defining a consumer transaction discount program 118 that authorizes a full payment of the electronic transaction on the payment account 116 and to an account such as merchant account 120. The program 118 further causes the server 104 to credit the payment account 116 the discount amount when the electronic transaction matches one of the at least one discounted transaction type and where the payment account matches the at least one account type, as stored in the discount database 106. The transaction discount program 118 further may cause the server 104 to debit the at least one sponsor account for the discount amount. In this way a network payment provider can enable a sponsor, such as a credit card issuer or a merchant to provide a consumer a discount for specific transaction types identified in the discount database 106 while providing the merchant making the sale with a full payment. The cost of the discount amount provided is paid from the sponsor account. The discount database 106, the sponsor account 108, the payment account 116, the transaction discount program 118, and the merchant account 120 are shown connected to server 104 via dashed lines representing that each item is a part of the server 104 or that the server 104 is further configured to connect to other servers or devices that contain the items shown. For example, the payment account 116 information may be housed in a first server or database at a first location, the sponsor account 108 information may be housed in a second server or database at a second location, and so on for each item identified.

The term consumer as used herein is a person or entity with an account for use on the network payment provider system. The consumer may or may not have an actual payment card. The payment account may be any type of account available from the network payment provider, such as a credit account, a debit account, or a prepaid account, etc. Similarly, the term account type may be any provided and may include a credit account, a debit account, or a prepaid account, etc.

The discounted transaction types may include a minimum spend amount, a minimum spend amount with a merchant, a purchase of a defined product or service, and a purchase of a product or service that includes a surcharge fee. A transaction of a purchase of a defined product may be for a particular type of purchase, such as fuel, electronics, travel, hotel rental, car rental, performance tickets, athletic tickets, money remittance services, money orders, or any purchase that a sponsor (merchant, bank, organization, etc.) may choose to provide a discount. The discounted transaction types may include a specific type or brand of product, a service, a combination of products, and a combination of products and services. Further, the discounted transaction types may be provided when used with a particular account type. For example, certain transactions may be discounted for debit or prepaid accounts, but not for credit accounts.

The sponsor account 108 may be an account of a single entity or it may be an account representing multiple parties that are participating in a discount program. If multiple parties are involved the server may apportion the discount among multiple accounts of the multiple parties as may be defined in the discount database. The sponsor account 108 may include a network payment provider account, a credit issuer account, an account associated with an acquirer of transactions, and a merchant account. The credit issuer account may be an account of any entity that issues transaction discounts, rebates, etc., i.e. credits. Also, the discount amount could be a specific amount of a percentage of a transaction amount. In the example of reimbursing fees associated with a transaction the discount amount could be for all or a portion of the fees charged, again as defined in the discount database.

The payment device 112 may be any appropriate device such as a credit card, a debit card, a prepaid card, a non-contact device (e.g. a radio frequency (RF) fob, an RF automobile toll device, etc.), a mobile telecommunication device (e.g. a cellular telephone, a smart phone, etc.), and a computer device (e.g. a personal computer, a laptop, a tablet, a card reader, or a combination of computer devices). The phrase “object of the electronic transaction” may be a part of transaction data identifying the electronic transaction made and refers to a subject matter of the transaction, such as a specific type or brand of product, a service, a combination of products, and a combination of products and services.

A specific example of a discounted transaction is where a cardholder makes a purchase of $100 on a prepaid card from a U.S. Post Office branch for a money order. The prepaid card will be charged the $100 plus a service fee of $1.20 for issuing the money order. The prepaid card will be charged the full payment of $101.20. If the U.S. Post Office purchase (electronic transaction) matches a discounted transaction type in the discount database 106 the server 104, through the program 118, will credit the payment account (the account linked to the prepaid card) the discount amount set in the database 106, in this case $1.20 or some portion thereof. The server 104, via the transaction discount program 118, will debit a sponsor account for the discount amount credited to the prepaid card. The transaction type in this instance may be as simple as any electronic transaction in the U.S. Post Office over $50, or over $100, made with a prepaid card. The sponsor may be an employer of the cardholder who pays the cardholder with a prepaid card instead of a traditional check or direct deposit. The employer may wish to relieve the employee cardholder of some of the fees associated with using a prepaid card. In this way, the U.S. Post Office still receives revenue for issuing a money order, the cardholder does not incur any fees for obtaining a money order, and the employer provides a benefit to a valued employee.

In this example, based on historical purchase data any purchase at the U.S. Post Office with a prepaid card for more than $50 is almost always (over 99% of the time) for a money order. Therefore, in this example, the transaction type in database 106 will identify a U.S. Post Office transaction for at least $50 with a prepaid card issued by the employer and when a matching electronic transaction is identified at server 104 via the transaction discount program 118 the appropriate discount amount of $1.20 will be credited to the prepaid card and debited to the employer sponsor account.

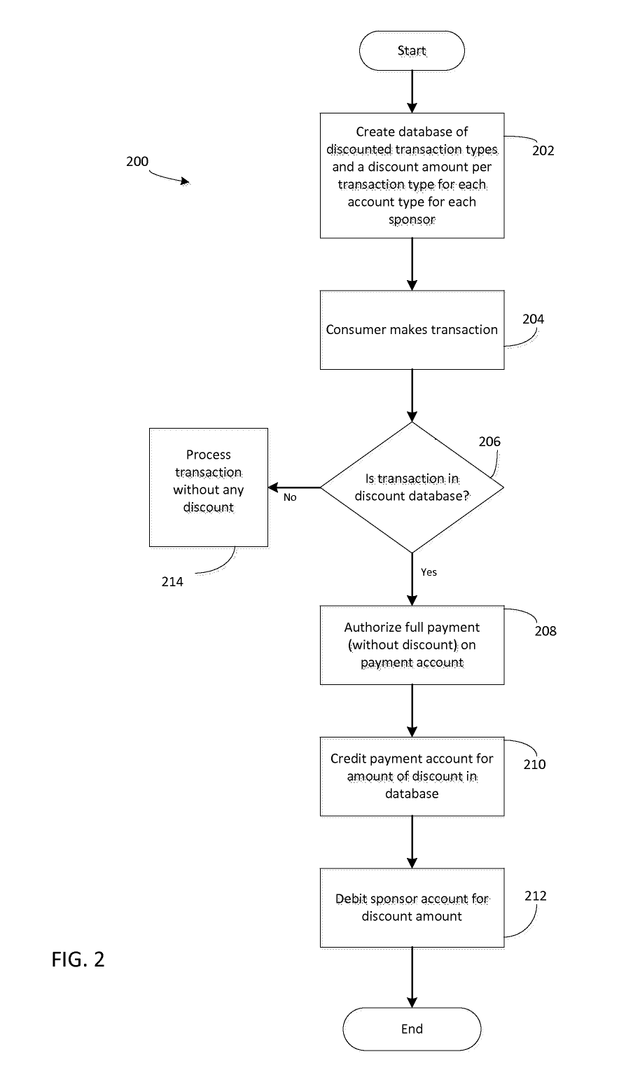

FIG. 2 is a flowchart 200 setting forth the logic flow of an example discount transaction program 118 embodied in server 104. The logic shows creating at 202, in memory 102, a discount database 106 of discounted transaction types and a discount amount per discounted transaction type for one or more account types, including associating each discounted transaction type with at least one sponsor account. The discount database 106 may be created by a network payment provider, as shown, or by any appropriate third party and stored in memory 102. Process 204 represents receiving, at server 104, an electronic transaction from a payment device 112 associated with a payment account. Process 206 decides if the electronic transaction at 204 matches a transaction type in discount database 106. If yes, the server 104, via program 118, authorizes a full payment of the electronic transaction on the payment account at 208. Process 210 represents crediting the payment account the discount amount for each electronic transaction matching one of the discounted transaction types when the payment account matches the account type using the server 104 coupled to the memory 102. The server 104 includes computer-executable instructions defining a transaction discount program 118. Process 212 represents debiting the sponsor account for the discount amount using the transaction discount program 118. If the decision at 206 is no, process 214 represents processing the received electronic transaction without any discount. The flowchart 200 shows step 212 occurring after step 210; however, it will be appreciated that steps 210 and 212 could be reversed or steps 210 and 212 could occur essentially simultaneously after step 208.

The foregoing description of the embodiments has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following exemplary operations, or any other operation described herein: (a) creating, in a memory, a discount database of at least one discounted transaction type and a discount amount per discounted transaction type for at least one account type including associating each discounted transaction type with at least one sponsor account; (b) receiving, at a server, an electronic transaction from a payment device associated with a payment account; (c) authorizing a full payment of the electronic transaction on the payment account and crediting the payment account the discount amount for each electronic transaction matching the at least one discounted transaction type when the payment account matches the at least one account type using the server coupled to the memory wherein the server includes computer-executable instructions defining a consumer transaction discount program; and (d) debiting the at least one sponsor account for the discount amount using the consumer transaction discount program.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A transaction discount system comprising:
a memory including a discount database of at least one discounted transaction type and a discount amount per discounted transaction type for at least one account type and wherein each discounted transaction type is associated with at least one sponsor account;
a server receiving an electronic transaction from a payment device associated with a payment account;
the server coupled to the memory wherein the server includes computer-executable instructions defining a consumer transaction discount program that authorizes a full payment of the electronic transaction on the payment account and further credits the payment account the discount amount when the electronic transaction matches one of the at least one discounted transaction type and where the payment account matches the at least one account type; and
wherein the consumer transaction discount program further debits the at least one sponsor account for the discount amount.

2. The system of claim 1 wherein the at least one discounted transaction type includes at least one of a minimum spend amount, a minimum spend amount with a merchant, a purchase of a defined product, and a purchase of a product that includes a surcharge fee.

3. The system of claim 1 wherein the at least one account type includes at least one of a credit account, a debit account, and a prepaid account.

4. The system of claim 1 wherein the at least one sponsor account includes at least one of a network payment provider account, a credit issuer account, and a merchant account.

5. The system of claim 1 wherein the payment device includes at least one of a credit card, a debit card, a prepaid card, a non-contact device, a mobile telecommunication device, and a computer device.

6. A computer-implemented method for applying a transaction discount to a payment account, the method comprising:
creating, in a memory, a discount database of at least one discounted transaction type and a discount amount per discounted transaction type for at least one account type including associating each discounted transaction type with at least one sponsor account;
receiving, at a server, an electronic transaction from a payment device associated with a payment account;
authorizing a full payment of the electronic transaction on the payment account and crediting the payment account the discount amount for each electronic transaction matching the at least one discounted transaction type when the payment account matches the at least one account type using the server coupled to the memory wherein the server includes computer-executable instructions defining a consumer transaction discount program; and
debiting the at least one sponsor account for the discount amount using the consumer transaction discount program.

7. The method of claim 6, wherein the creating the discount database includes identifying the at least one discounted transaction type as at least one of a minimum spend amount, a minimum spend amount with a merchant, a purchase of a defined product, and a purchase of a product that includes a surcharge fee.

8. The method of claim 6, wherein the creating the discount database includes identifying the at least one account type as at least one of a credit account, a debit account, and a prepaid account.

9. The method of claim 6, wherein the creating the discount database includes identifying the at least one sponsor account as at least one of a network payment provider account, a credit issuer account, and a merchant account.

10. The method of claim 6, wherein the receiving the electronic transaction includes identifying the payment device as at least one of a credit card, a debit card, a prepaid card, a non-contact device, a mobile telecommunication device, and a computer device.

11. A transaction discount system comprising:
a server receiving an electronic transaction associated with a payment account, the electronic transaction including transaction data identifying at least an amount of the electronic transaction, an object of the electronic transaction, an issuer of the payment account, and a merchant;
a memory coupled to the server including a discount database of at least one discounted transaction type and a discount amount per discounted transaction type for at least one account type and wherein each discounted transaction type is associated with at least one sponsor account;
wherein the server includes computer-executable instructions defining a consumer transaction discount program that authorizes a full payment of the electronic transaction on the payment account and further credits the payment account the discount amount when the electronic transaction matches one of the at least one discounted transaction type and where the payment account matches the at least one account type; and
wherein the consumer transaction discount program further debits the at least one sponsor account for the discount amount.

12. The system of claim 11, the transaction data further identifying a fee associated with the electronic transaction and wherein the discount amount is equal to the fee associated with the electronic transaction.

13. The system of claim 11 wherein the at least one discounted transaction type includes at least one of a minimum spend amount, a minimum spend amount with a merchant, a purchase of a defined product, and a fee associated with the purchase of the defined product.

14. The system of claim 11 wherein the at least one account type includes at least one of a credit account, a debit account, and a prepaid account.

15. The system of claim 11 wherein the at least one sponsor account includes at least one of a network payment provider account, a credit issuer account, and a merchant account.

16. The system of claim 11 wherein the electronic transaction originates from a payment device including at least one of a credit card, a debit card, a prepaid card, a non-contact device, a mobile telecommunication device, and a computer device.
